(19) United States
(12) Patent Application Publication
(10) Pub. No.: US 2015/0347681 A1
(43) Pub. Date: Dec. 3, 2015

(54) SYSTEM AND METHOD FOR HEALTH INFORMATION EXCHANGE AND ANALYTICS

(71) Applicant: VYNCA, LLC, Mountain View, CA (US)

(72) Inventors: Rush L. BARTLETT, II, Mountain View, CA (US); David LIN, Cupertino, CA (US); Ryan J.F. VAN WERT, Palo Alto, CA (US); Frank T. WANG, Cupertino, CA (US)

(21) Appl. No.: 14/724,280

(22) Filed: May 28, 2015

Related U.S. Application Data
(60) Provisional application No. 62/004,889, filed on May 30, 2014.

(51) Int. Cl. G06F 19/00; G06F 17/30

(52) U.S. Cl. CPC G06F 19/321; G06F 17/3028; G06F 17/30321; G06F 17/30342

(57) ABSTRACT

A method for processing Health Level 7 (HL7) data may involve: receiving multiple HL7 data feeds from multiple distinct locations; mapping data contained in the multiple HL7 data feeds; entering the data from the multiple HL7 data feeds into a non-relational database; performing initial indexing of the data; using the data to perform analytic tasks; and performing indexing functions on previously stored HL7 data.

### CROSS-REFERENCE TO RELATED APPLICATION(S)

This application claims priority to U.S. Provisional Patent Application No. 62/004,889, entitled “System and Method for Health Information Exchange and Analytics,” filed on May 30, 2014. The full disclosure of the above-listed patent application is hereby incorporated by reference herein.

### BACKGROUND

Health Level Seven (HL7) is an organization that develops data standards for exchanging information across the healthcare industry, including clinical documentation, laboratory, pharmacy, clinical trials and human subjects research, billing, claims and reimbursement.

The HL7 standard defines data feeds containing particular kinds of data. For example the Admission, Discharge and Transfer feeds contain patient demographics and specific information regarding the reason and care setting in which a patient is receiving care. HL7 version two messages use an order-based nomenclature, in which data objects are identified by segments, fields and subfields, each of which is defined as an ordinal relative to the higher order classification. HL7 version three, on the other hand, uses a hierarchical structure, namely eXtensible Markup Language (XML), and is a format that is machine-readable and human readable.

There is often a desire to store healthcare data in computer systems for analysis, storage or transmission between computer systems. The traditional means of storing HL7 messages is in a relational database. Relational databases store data objects according to a predefined tabular schema, wherein rows and columns contain data objects of a specific type, which may be referenced between various tables in the database. However, relational databases are fundamentally limited, in that they require data fields to be defined ab initio. In this way, data objects identified by a particular order or tree-based nomenclature may be parsed from an HL7 feed and used to populate the corresponding components of the database. However, data objects that are not pre-specified will not be collected and stored in the database management system. This results in potentially lost opportunities for data analytics, if a process, hypothesis or other data query is contemplated after the initial data set has been collected. As such, there remains a need for a way to store bulk health data information in a format that facilitates analysis at a later time, without having to pre-define data objects.

### BRIEF SUMMARY

The present disclosure describes a means through which HL7 data feeds are processed and stored in a non-relational database. Non-relational databases do not rely on pre-defined tables and instead store data in individual arrays with individually labeled objects. The disclosed system and method provide various ways by which these arrays may be indexed at the time of data entry into the database, or alternatively may be retrospectively indexed at a later time to perform specific analyses or queries of healthcare information including but not limited to HL7 messages or any part of the layer of the HL7 message framework. The disclosed system and method facilitate the bulk collection and storage of healthcare data for a vast array of present and future data analytics and transmission of (and on) that healthcare data.

In one aspect, a method for processing Health Level 7 (HL7) data may include: receiving multiple HL7 data feeds from multiple distinct locations; mapping data contained in the multiple HL7 data feeds; entering the data from the multiple HL7 data feeds into a non-relational database; performing initial indexing of the data; using the data to perform analytic tasks; and performing indexing functions on previously stored HL7 data. In some embodiments, the data from the multiple HL7 data feeds is stored in the non-relational database before it is indexed. Alternatively, the data from the multiple HL7 data feeds may be indexed before it is stored in the non-relational database.

In some embodiments, the analytic tasks are performed at the same time that the data from the multiple HL7 data feeds is stored in the non-relational database and indexed. In some embodiments, the analytic tasks are performed after the data from the multiple HL7 data feeds is stored in the non-relational database and indexed. In some embodiments, receiving the multiple HL7 feeds involves receiving feeds in the form of FHIR, webservices, XML, XDS, any version of HL7, and/or any other standard by which healthcare data is transmitted from a healthcare database. In some embodiments, receiving the multiple HL7 feeds involves accepting and matching HL7 data from more than one network or system and storing it in a single non-relational database. In some embodiments, receiving the multiple HL7 feeds involves accepting and matching HL7 data from more than one network or system and storing it in the non-relational database and at least one relational database, where identifying healthcare demographics data used for patient matching are stored in the relational database and are linked to an entire set of the HL7 data stored in the non-relational database. In some embodiments, the method may further involve searching for data related to one or more patients in the non-relational database and matching patients with the data, using the non-relational database.

These and other aspect and embodiments are described in greater detail below, in reference to the attached drawing figures.

### BRIEF DESCRIPTION OF THE DRAWINGS

FIG. 1 is a diagram illustrating a system architecture, according to one embodiment;

FIG. 2 is a diagram illustrating transmission, storage and processing of HL7 messages between a variety of users of a system, according to one embodiment;

FIG. 3 is a diagram illustrating processing of an HL7 version 2 message, according to one embodiment;

FIG. 4. is a diagram illustrating the processing of an HL7 version 3 message, according to one embodiment;

FIG. 5 is a diagram illustrating transmission, storage and processing of HL7 messages between a variety of users of a system, according to one embodiment;

FIG. 6 is a diagram illustrating an exemplary system interacting with various facets of healthcare computer systems, according to one embodiment.

The drawings are not intended to be limiting in any way, and various embodiments may be carried out in a variety of other ways, including those not necessarily depicted in the drawings.

### DETAILED DESCRIPTION

The following description of certain examples of the invention should not be used to limit the scope of the present invention. The drawings and descriptions should be regarded as illustrative in nature and not restrictive.

The embodiments of system described herein include components for performing at least some of the following tasks: (i) receiving HL7 data feeds; (ii) parsing and mapping the messages as required; (iii) entering the data into a non-relational database; (iv) performing an initial indexing of data; (vi) utilizing the data to perform analytics or other tasks; and (vii) performing indexing functions on previously stored data.

HL7 messages may be received and parsed in version 2 or version 3 formats. The present invention may also apply to any HL7 format currently in existence or yet to be established, as well as other mechanisms of health data transmission from any healthcare setting. HL7 messages may or may not be processed by an interface engine. HL7 version 2 messages may be mapped to a hierarchical organizational structure, including but not limited to XML.

Initial indexing of the data may occur, to facilitate analysis of the data in the database, including but not limited to patient identifiers, diagnosis, and healthcare provider. Subsequent indexing processes may occur on part or all of the data in the database, to facilitate subsequent analysis, including but not limited to, trends in patient health history at a location or across multiple locations, mapping or matching data at different locations to congregate information about a patient or many patients that have visited multiple locations, analyzing de-identified trends in healthcare information across one or more locations, analyzing payment or insurance information, including but not limited to for the use of fraud detection, and/or many additional uses for data collection and analytics.

The present invention also can be used in conjunction with a conversion engine for various types of HL7 messages and versions and/or other types of healthcare data, which can be converted to a HL7 message prior to being used with the system or an HL7 message that can be converted to another message format prior to being collected by the system. For example, an HL7 version 2 message may be converted to a HL7 version 3 message prior to storage in the non-relational database. This facilitates a unified storage format for the data. In addition, the data can be re-converted to another HL7 format once retrieved from the database, if desired, such as from a HL7 version 3 format stored in the non-relational database to a HL7 version 2.3 message that would be sent back into a health system. This type of conversion of message types and/or the storage of information in the non-relational format from health data messages is not limited to HL7 and may be used with other types of health data information formats and strategies, such as but not limited to: Integrating the health enterprise (IHE), Cross-community patient discovery (XCPD), Cross-enterprise document sharing (XDS), Cross-community access query and retrieve services (XCA), Audit trail and node authentication (ATNA), Interoperability, Orchestration, Choreography, Web services, Service oriented architecture (SOA), Enterprise service bus (ESB), Health information exchange (HIE), Simple object access protocol (SOAP), Representational State Transfer (REST), Business process execution language (BPEL), Encryption, Signature, Security assertion markup language (SAML) and/or other different types of data transmission mechanisms.

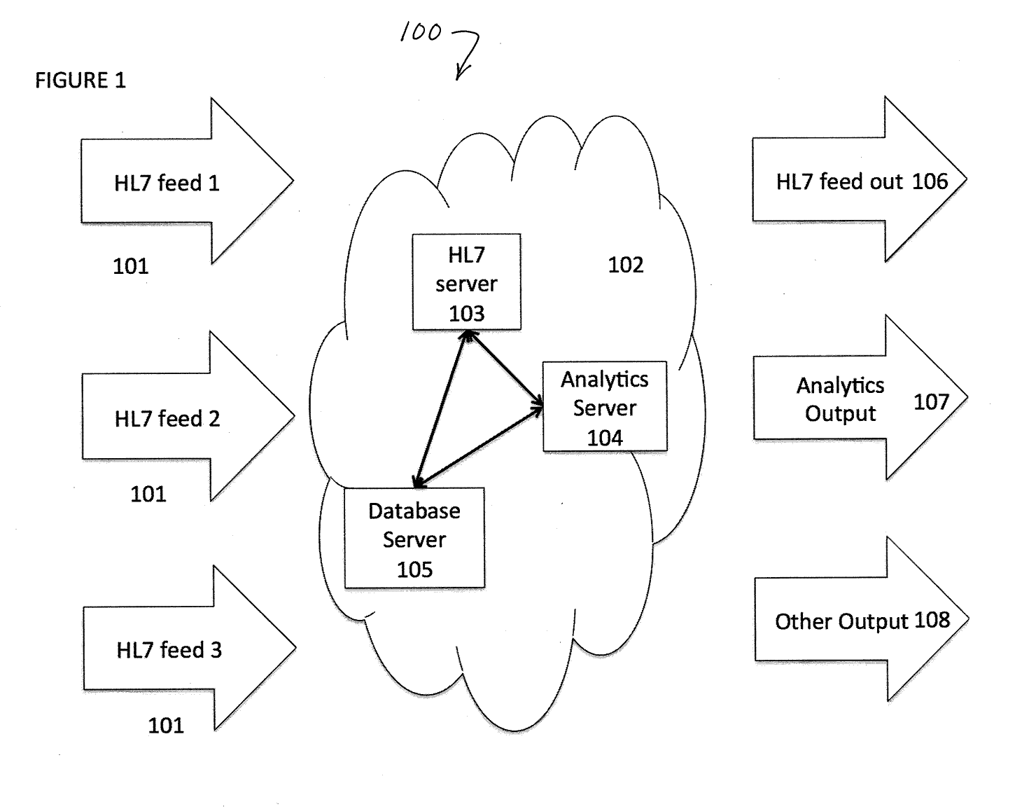

FIG. 1 shows an exemplary system architecture (100), according to one embodiment. HL7 feeds (101) from various healthcare computer systems, individual users and/or other entities are received into the cloud (102). The cloud-based HL7 server (103) performs parsing and mapping functions, including but not limited to hierarchical structures such as HL7 version 3, XML. The HL7 server (103) interfaces with both the database server (105) to facilitate storage of data in the non-relational database and also the analytics server (104) to perform analytics functions. The servers (103), (104, (105) together facilitate the generation of outgoing HL7 feeds (106), analytics outputs in a variety of formats (107), and other outputs (108), as required by end users. Although the servers (103), (104, (105) are depicted in FIG. 1 as single servers, in any embodiment any or all of the servers (103), (104, (105) may actually be multiple servers. Similarly, although HL7 is depicted in FIG. 1, in various embodiments any other health data information formats may be used, alone or in combination.

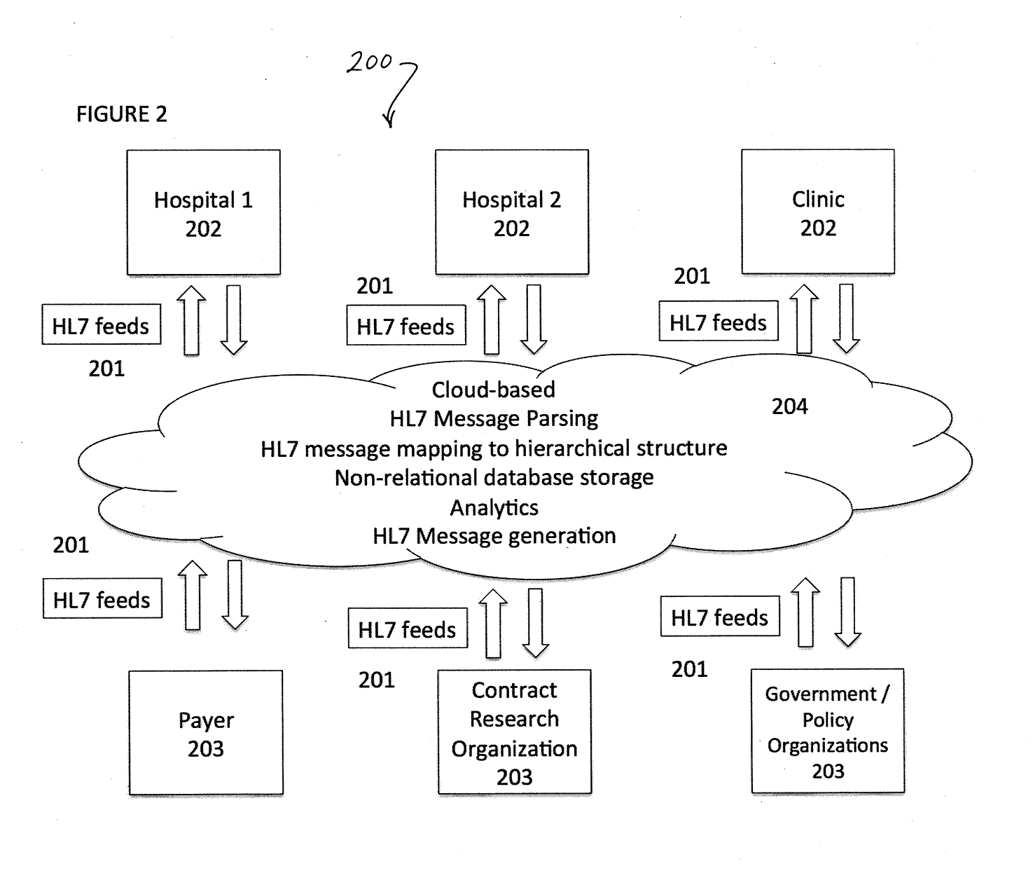

FIG. 2 depicts an exemplary method (200) for processing HL7 messages, according to one embodiment. HL7 feeds (201) are received and sent from various healthcare computer systems (202), and other healthcare-related computer systems (203), including but not limited to payers, contract research organizations, and governmental/policy organizations. Various functions for the collection, processing, storage and transmission of the messages occurs in the cloud (204). As for all the drawing figures in this application, where HL7 is depicted, any other suitable health data information formats may be used in addition or alternatively.

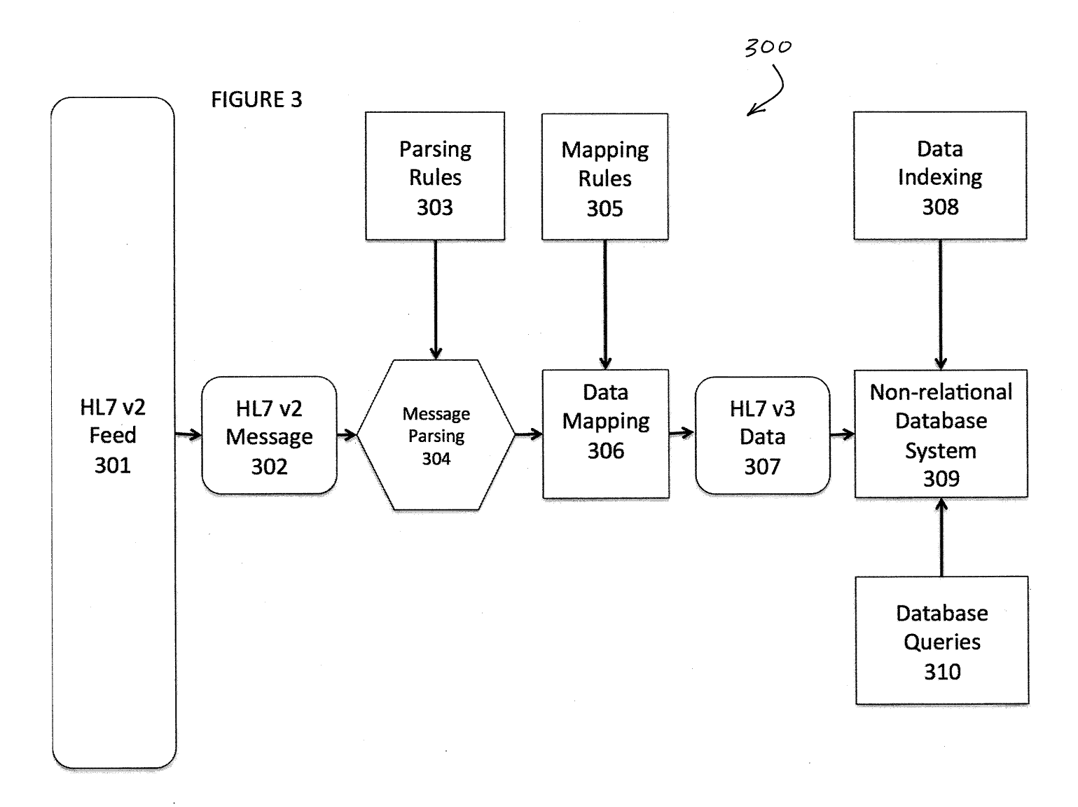

FIG. 3 is a flow diagram illustrating a method (300) for managing the flow of HL7 version 2 messages into a non-relational database, according to one embodiment. First, HL7 version 2 messages (302) may be sent in an HL7 version 2 feed (301). Then, messages are parsed (304) using pre-specified parsing rules (303). Parsed data are subsequently mapped (306), using pre-specified mapping rules (305), in this case rules supporting the conversion of HL7 version 2 data into HL7 version 3 data (307). Such hierarchically structured data is then input to the non-relational database system (309), where indexing functions (308) and queries (309) may occur.

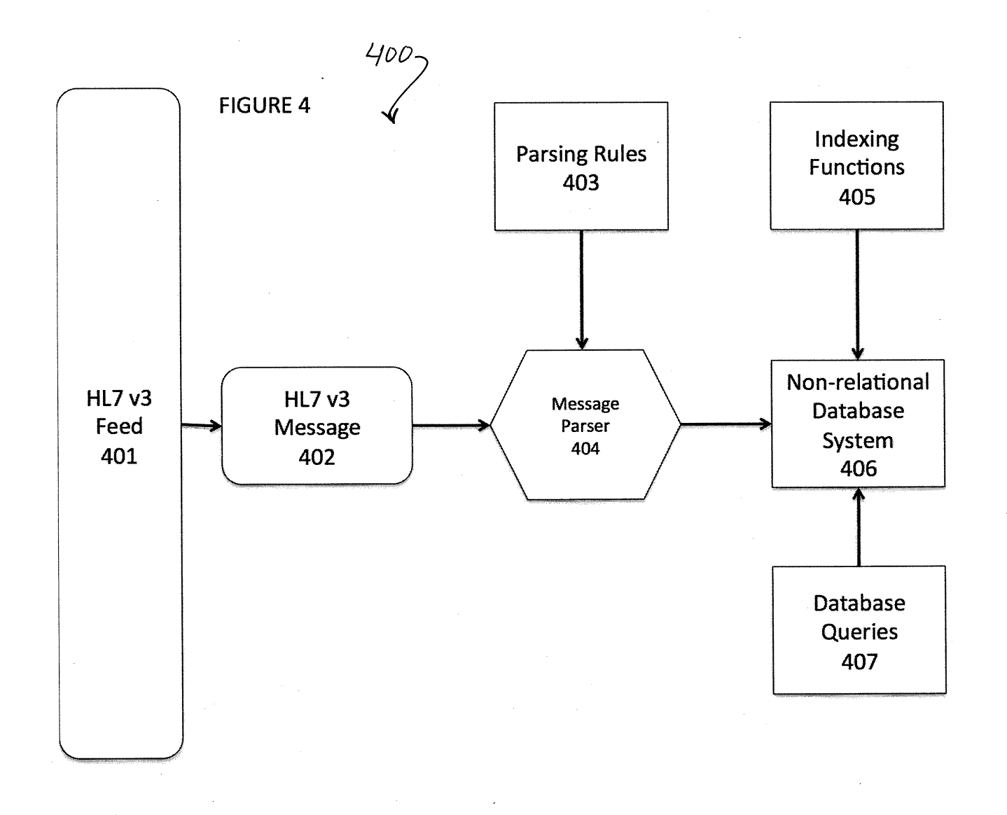

FIG. 4 is a flow diagram illustrating a method (400) for managing the flow of HL7 version 3 messages into a non-relational database, according to one embodiment. First, HL7 version 3 messages (402) are parsed (404) using pre-specified parsing rules (403). Such hierarchically structured data is then input to the non-relational database system (406), where indexing functions (405) and queries (407) may occur.

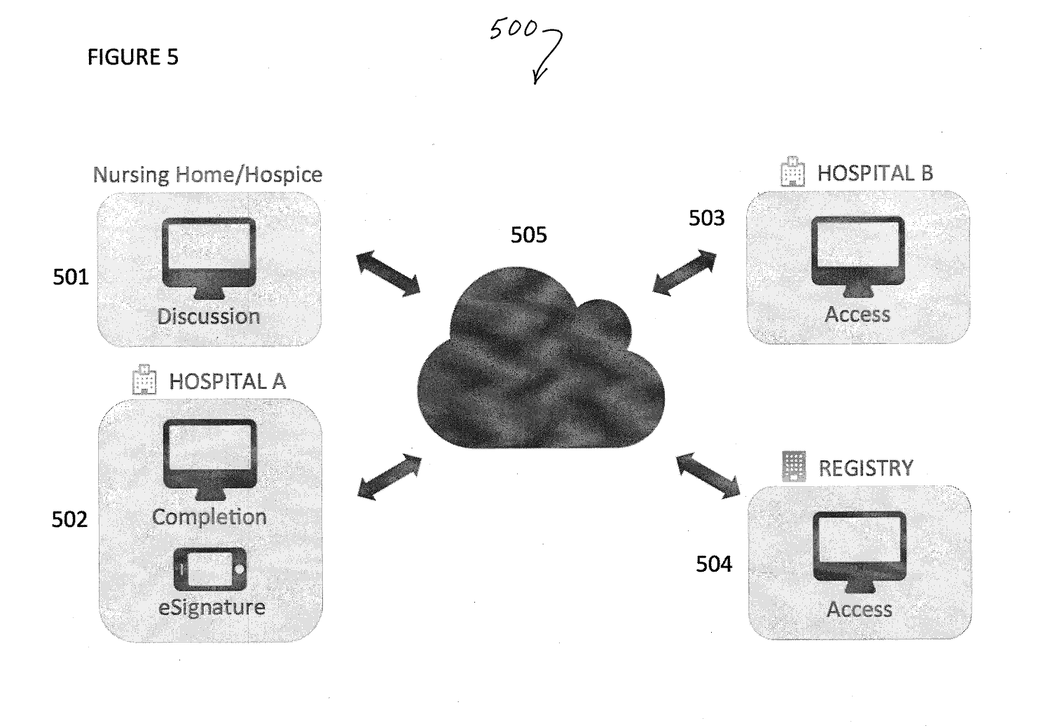

FIG. 5 depicts an exemplary system (500), according to one embodiment. In this example, data for patient education are displayed at a nursing home (501). Specified documents and electronic signature collection may subsequently occur at hospital A (502) for the same patient, and the documents may then be accessed at hospital B (503) and/or sent to a central registry (504). This functionality, including but not limited to patient matching, data collection, processing, storage and access occurs in the cloud (505).

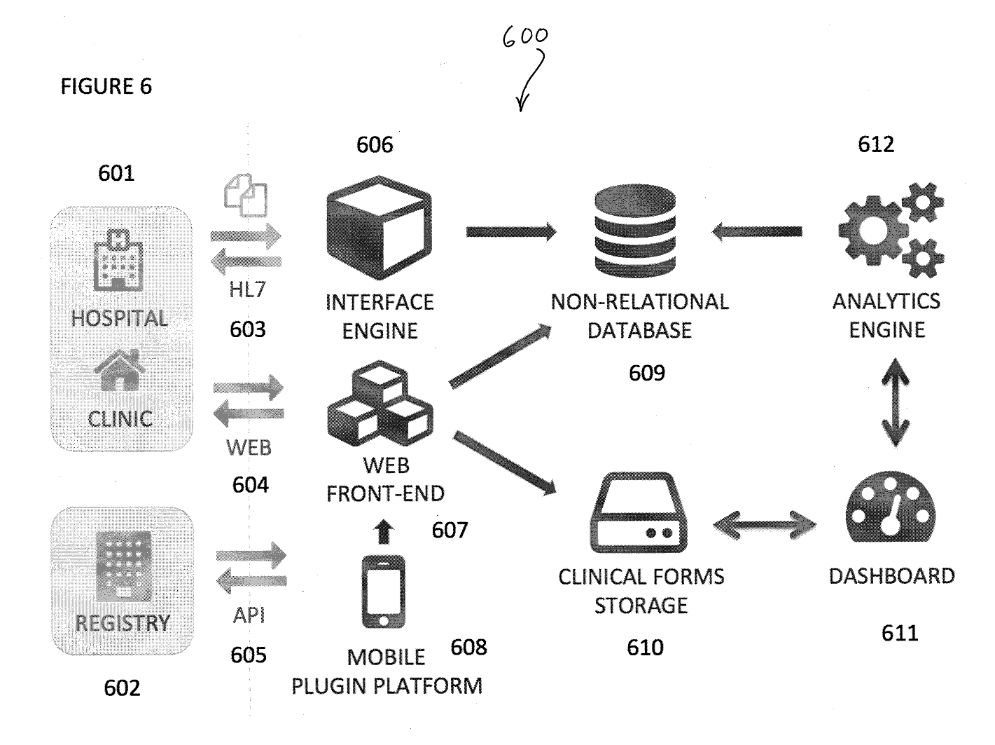

FIG. 6 depicts an exemplary system (600) interacting with various facets of healthcare computer systems. Hospitals and clinics (601) may interact with interface engines (606) to send and receive HL7 data (603). The hospitals and clinics (601) may also use web-based means (604) to interact with front-end web tools (607), which may further interact with mobile plug-in platforms (608). A non-relational database (609) may receive data from both web-based tools (607) and an interface engine (606). Web-based tools and clinical dashboards (611) may also interface with clinical form document management system (610). Finally, an analytics engine (612) may interface with both the non-relational database (609) and the dashboard (611).

What is claimed is:

1. A method for processing Health Level 7 (HL7) data, the method comprising:
receiving multiple HL7 data feeds from multiple distinct locations;
mapping data contained in the multiple HL7 data feeds;
entering the data from the multiple HL7 data feeds into a non-relational database;
performing initial indexing of the data;
using the data to perform analytic tasks; and
performing indexing functions on previously stored HL7 data.

2. A method as in claim 1, wherein the data from the multiple HL7 data feeds is stored in the non-relational database before it is indexed.

3. A method as in claim 1, wherein the data from the multiple HL7 data feeds is indexed before it is stored in the non-relational database.

4. A method as in claim 1, wherein the analytic tasks are performed at the same time that the data from the multiple HL7 data feeds is stored in the non-relational database and indexed.

5. A method as in claim 1, wherein the analytic tasks are performed after the data from the multiple HL7 data feeds is stored in the non-relational database and indexed.

6. A method as in claim 1, wherein receiving the multiple HL7 feeds comprises receiving feeds in a form selected from the group consisting of FHIR, webservices, XML, XDS, any version of HL7, and any other standard by which healthcare data is transmitted from a healthcare database.

7. A method as in claim 1, wherein receiving the multiple HL7 feeds comprises accepting and matching HL7 data from more than one network or system and storing it in a single non-relational database.

8. A method as in claim 1, wherein receiving the multiple HL7 feeds comprises accepting and matching HL7 data from more than one network or system and storing it in the non-relational database and at least one relational database, wherein identifying healthcare demographics data used for patient matching are stored in the at least one relational database and are linked to an entire set of the HL7 data stored in the non-relational database.

9. A method as in claim 8, further comprising:
searching for data related to one or more patients in the non-relational database; and
matching patients with the data, using the non-relational database.
